(19) United States
(12) Patent Application Publication
(10) Pub. No.: US 2003/0133744 A1
(43) Pub. Date: Jul. 17, 2003

(54) Ball joint with dual tapered connection

(75) Inventor: Brian A. Urbach, Rochester Hills, MI (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Inc.

(21) Appl. No.: 10/047,534

(22) Filed: Jan. 15, 2002

(51) Int. Cl. F16C 11/00

(52) U.S. Cl. 403/135

(57) ABSTRACT

An apparatus comprises a first suspension member (12), and a second suspension member (14) having a through hole (24) with a first tapered surface (32) defining a first end of the through hole and a second tapered surface (34) defining a second end of the through hole. A socket (40) is connected with the first suspension member (12). A stud (50) has a first end portion (52) and a second end portion (60). The socket (40) supports the first end portion (52) of the stud (50) in the socket (40) for pivotal movement relative to the socket. The second end portion (60) of the stud (50) has a tapered outer surface (66) in engagement with the first tapered surface (32) of the second suspension member (14). A fastener (90) on the second end portion (60) of the stud (50) has a tapered outer surface (96) in engagement with the second tapered surface (36) of the second suspension member (14).

### BACKGROUND OF THE INVENTION

1. Technical Field

The present invention relates to a ball joint that supports a first suspension member for movement relative to a second suspension member. In particular, the present invention relates to a vehicle ball joint that has a tapered stud for attachment to a control arm or other suspension member.

2. Description of the Prior Art

A typical motor vehicle suspension includes a plurality of members, such as control arms, steering knuckles, etc., which are interconnected for relative movement by ball joints. The ball joint typically includes a tapered stud to be received in a tapered bore in the suspension member.

It is known to provide a vehicle lug nut that has a tapered end for engaging a tapered end of a stud opening in a vehicle wheel.

### SUMMARY OF THE INVENTION

The present invention is an apparatus comprising a first suspension member, and a second suspension member having a through hole with a first tapered surface defining a first end of the through hole and a second tapered surface defining a second end of the through hole. A socket is connected with the first suspension member. A stud has a first end portion and a second end portion. The socket supports the first end portion of the stud in the socket for pivotal movement relative to the socket. The second end portion of the stud has a tapered outer surface in engagement with the first tapered surface of the second suspension member. A fastener on the second end portion of the stud has a tapered outer surface in engagement with the second tapered surface of the second suspension member. The socket and the stud support the first suspension member for movement relative to the second suspension member.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a sectional view of a portion of a vehicle suspension including an apparatus constructed in accordance with the present invention; and

FIG. 2 is an enlarged view of a portion of the apparatus of FIG. 1.

### DETAILED DESCRIPTION OF THE INVENTION

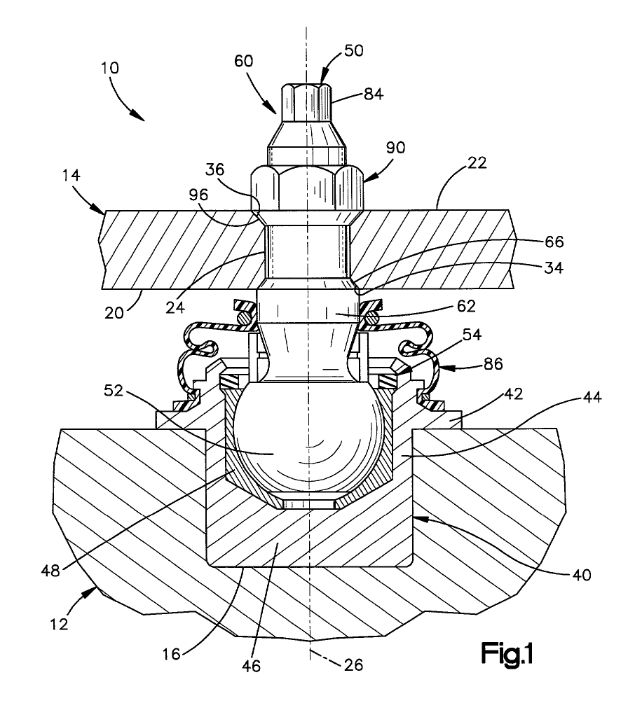

The present invention relates to a ball joint that supports a first suspension member for movement relative to a second suspension member. The present invention is applicable to various ball joint constructions. As representative of the invention, FIG. 1 illustrates a ball joint 10. The ball joint 10 is located between a first suspension member shown partially at 12 and a second suspension member shown partially at 14.

The first suspension member 12 may be a steering knuckle or steering yoke, for example. The first suspension member 12 has a cylindrical socket opening 16 for receiving the ball joint 10. The second suspension member 14 may be a control arm or steering yoke or steering knuckle, for example.

The second suspension member 14 has first and second opposite side surfaces 20 and 22. The second suspension member 14 has a through hole 24 that extends between the side surfaces 20 and 22. The through hole 24 has a generally cylindrical configuration centered on an axis 26 and defined by a cylindrical surface 28 that extends parallel to the axis.

A first end 30 of the through hole 24 has a first frustoconical surface or chamfer 32 that extends between the cylindrical surface 28 and the first side surface 20. In the illustrated embodiment, the first chamfer 32 extends at an angle of 45 degrees to the axis 26. The angle could be different in different embodiments.

The opposite second end 34 of the through hole 24 has a second frustoconical surface or chamfer 36 that extends between the cylindrical surface 28 and the second side surface 22. In the illustrated embodiment, the second chamfer 36 extends at an angle of 45 degrees to the axis 26. The angle could be different in different embodiments.

The ball joint 10 includes a socket 40 and a ball stud 50. A mounting flange 42 extends radially outward from a side wall 44 of the socket 40, adjacent to a closed lower end 46 of the socket. The socket 40 is mounted in the opening 16 in the first suspension member 12. The socket 40 is thus fixed for movement with the first suspension member 12.

A bearing 48 is located in the socket 40. A ball end portion 52 of the ball stud 50 is received in the bearing 48. The ball end portion 52 is rotatable and pivotable in the bearing 48 to provide for relative movement between the first suspension member 12 and the ball stud 50. A retainer 54 holds the bearing 48 in place in the socket 40.

The ball stud 50 has a shank portion 60. The shank portion 60 has a first section 62 that extends from the ball end portion 52 of the ball stud 50 in a direction away from the ball end portion. The first section 62 has a cylindrical configuration centered on the axis 26.

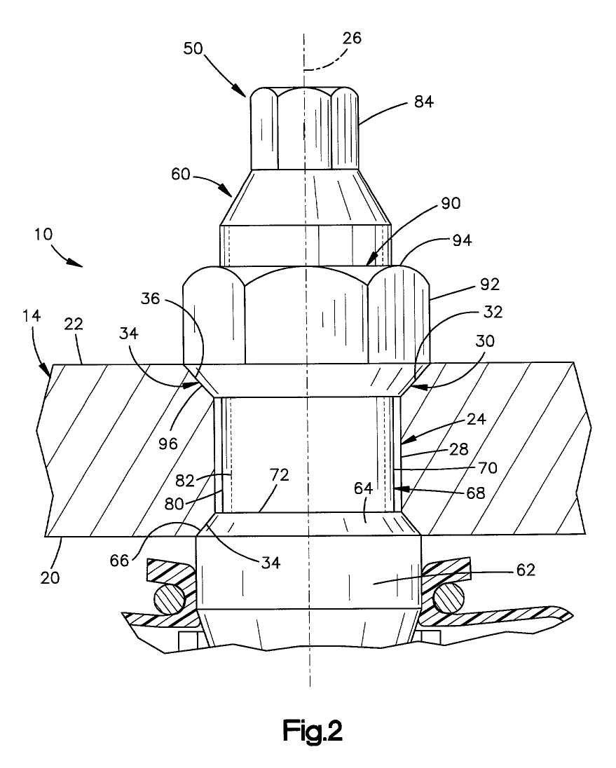

The shank portion 60 also has a second section 64 that extends from the first section 62 in a direction away from the ball end portion 52. The second section 64 has a tapered outer surface 66 centered on the axis 26 and extending at an angle (FIG. 2) to the axis. The outer surface 66 tapers at the same angle as the first chamfer 32 on the control arm 14. Thus, in the illustrated embodiment, the outer surface 66 extends at an angle of 45 degrees to the axis 26.

The shank portion 60 also has a cylindrical third section 68 that extends from the second section 64 in a direction away from the ball end portion 52 of the ball stud 50. A first part of the third section 68 has a cylindrical outer surface 70 centered on the axis 26. In the illustrated embodiment, the cylindrical surface 70 has a smaller diameter than the narrowest diameter of the tapered second section 64. As a result, an annular, radially extending shoulder surface 72 is formed and extends between the cylindrical surface 70 and the tapered surface 66.

An intermediate part 80 of the third section 68 of the shank portion 60 has an external thread 82. On its terminal end 84, the third section 68 of the shank portion 60 has a hexagonal configuration adapted to receive a hex socket wrench.

The ball joint 10 further includes a seal 86. The seal 86 extends between the socket 30 and the first section 62 of the shank portion 60 of the ball stud 50. The seal 86 prevents the ingress of contaminants into the ball joint 10 and the egress of lubricant from the ball joint.

The ball joint 10 also includes a nut 90. The nut 90 has a hexagonal outer side surface 92 for engagement by a hex socket wrench. The nut has a first or outer end surface 94 that extends perpendicular to the axis 26. The nut has a tapered or frustoconical inner end surface 96 centered on the axis 26 and presented toward the ball stud 50. The inner surface 96 tapers at the same angle as the second chamfer 36 on the control arm 14. Thus, in the illustrated embodiment, the inner end surface 96 of the nut 90 extends at an angle of 45 degrees to the axis 26.

In assembly of the ball joint 10 into the first and second suspension members 12 and 14, the socket 40 of the ball joint 10 is fitted in the opening 16 in the first suspension member 12. The ball joint 10 is, thereafter, assembled with the control arm 14. The shank portion 60 of the ball stud 50 is inserted into and through the through hole 24 in the control arm 14. The frustoconical outer surface 66 on the shank portion 60 of the ball stud 50 moves into abutting engagement with the first chamfer 32 on the control arm 14.

The nut 90 is screwed onto the projecting threaded portion 80 of the shank portion 60 of the ball stud 50 and tightened, into engagement with the control arm 14. The frustoconical inner end surface 96 on the nut 90 moves into abutting engagement with the second chamfer 36 on the control arm 14 in a tight, force-fitting connection. A hex wrench can be used on the terminal end 84 of the third section 68 of the shank portion 60 of the ball stud 50, to prevent the ball stud from rotating about the axis 26 when the nut 90 is tightened.

When the ball joint 10 is thus assembled to the control arm 14, stud pull through is not possible because the tapered surface 66 on the shank portion 60 of the ball stud 50 engages the first chamfer 32 on the control arm 14. Also, because of the presence of the first and second tapered surfaces 32 and 36 on opposite ends of the through hole 24 in the control arm 14, relaxation of the shank portion 60 of the ball stud 50 is limited, helping to preserve nut torque. The presence of the first and second tapered surfaces 32 and 36 also provides increased surface area for torque transfer.

From the above description of the invention, those skilled in the art will perceive improvements, changes and modifications in the invention. For example, the invention is usable in a ball joint that forms part of a tie rod end. Also, the suspension members between which the ball joint is connected can be any two relatively movable parts of a vehicle between which a tapered connection is used. Such improvements, changes and modifications within the skill of the art are intended to be covered by the appended claims.

Having described the invention, I claim:

1. Apparatus comprising:
a first suspension member;
a second suspension member having a through hole with a first tapered surface defining a first end of said through hole and a second tapered surface defining a second end of said through hole;
a socket connected with said first suspension member;
a stud having a first end portion and a second end portion;
said socket supporting said first end portion of said stud in said socket for pivotal movement relative to said socket;
said second end portion of said stud projecting from said socket and having a tapered outer surface in engagement with said first tapered surface of said second suspension member; and
a fastener on said second end portion of said stud, said fastener having a tapered outer surface in engagement with said second tapered surface of said second suspension member;
said socket and said stud supporting said first suspension member for movement relative to said second suspension member.

2. Apparatus as set forth in claim 1 wherein said stud has a longitudinal central axis on which said tapered outer surface of said stud is centered, said tapered outer surface of said stud extending at a first angle to said axis, said first and second tapered surfaces of said second suspension member extending at said first angle to said axis.

3. Apparatus as set forth in claim 2 wherein said tapered surface on said fastener extends at said first angle to said axis.

4. Apparatus as set forth in claim 2 wherein said tapered surface on said stud extends at a 45 degree angle to said axis.

5. Apparatus as set forth in claim 1 wherein said fastener is a nut and said second end portion of said stud has a threaded end portion for receiving said nut.

6. Apparatus as set forth in claim 1 wherein said second end portion of said stud has a cylindrical portion extending from said tapered surface of said stud in a direction away from said first end portion of said stud, said cylindrical portion having a smaller diameter than the smallest diameter of said tapered surface of said stud.

7. Apparatus as set forth in claim 1 wherein said stud has a longitudinal central axis on which said tapered outer surface of said stud is centered, said tapered outer surface of said stud extending at a first angle to said axis, said first and second tapered surfaces of said second suspension member extending at said first angle to said axis, said tapered surface on said fastener extending at said first angle to said axis, said fastener being a nut and said second end portion of said stud having a threaded end portion for receiving said nut.

8. Apparatus as set forth in claim 8 wherein said second end portion of said stud has a cylindrical portion extending from said tapered surface of said stud in a direction away from said first end portion of said stud, said cylindrical portion having a smaller diameter than the smallest diameter of said tapered surface of said stud.
